(19) United States
(12) Patent Application Publication
(10) Pub. No.: US 2024/0190490 A1
(43) Pub. Date: Jun. 13, 2024

(54) HAND CART

(71) Applicants: Michael W. Thomas, Redmond, WA (US); Darid Andrew Demulle, Renton, WA (US)

(72) Inventors: Michael W. Thomas, Redmond, WA (US); Darid Andrew Demulle, Renton, WA (US)

(73) Assignee: HOME TO AUTO, INC., REDMOND, WA (US)

(21) Appl. No.: 18/586,441

(22) Filed: Feb. 24, 2024

Related U.S. Application Data
(63) Continuation-in-part of application No. 17/150,468, filed on Jan. 15, 2021, now Pat. No. 11,945,486.

(51) Int. Cl. B62B 3/02; B62B 3/00; B62B 5/04; B62B 5/06

(52) U.S. Cl. CPC B62B 3/02; B62B 3/008; B62B 5/04; B62B 5/06; B62B 2301/22

(57) ABSTRACT

A hand cart provides a handlebar attached to a wheeled frame upon which is disposed a platform for carrying loads. Independently slidable sides surround the platform, providing walls to prevent loads from sliding off the platform. Some embodiments of the invention enable raising and lowering the platform. Embodiments provide user-operated normally engaged braking. A suspension system facilitates cart transport, keeping the cart generally level on uneven surfaces and enabling front and rear wheels to pass over barriers.

### CROSS-REFERENCE TO RELATED APPLICATION

This application is a continuation-in-part of U.S. utility patent application Ser. No. 17/150,468 titled “Self-Elevating Platform”, filed Jan. 15, 2021, incorporated herein by reference.

### BACKGROUND OF THE INVENTION

### Field of the invention

This specification relates to hand carts used for transporting cargo. More specifically, this application relates to hand carts configured to ensure releasable retention of cargo and adapted for transport over uneven surfaces by way of suspension. Description of the related art

Hand carts, or hand trucks, are hand-propelled wheeled vehicles, used from time immemorable for transporting loads. Typical hand carts comprise one or more handles for the driver, one or more transport wheels, and a means for carrying loaded cargo.

Some hand carts provide means for carrying specific cargo. Examples include carts or dollies with means for carrying trash cans (U.S. Pat. No. 2,984,500, U.S. Pat. No. 3,108,702, U.S. Pat. No. 5,000,467), cylindrical containers generally (U.S. Pat. No. 2,723,864), toilets (U.S. Pat. No. 5,373,593), and outboard motors (U.S. Pat. No. 2,843,393). These carts, configured for particular cargo, typically comprise means specifically designed to retain those loads.

Hand carts adapted for more general loads, however, generally simply provide one or more platforms or decks on which cargo may be loaded and unloaded. A typical platform for cargo is described in U.S. Pat. No. 9,834,241, in which a substantially horizontal deck is provided to carry loads. A problem presented in this approach for carrying loads is that operation of the cart in transport may result in forces on the load, as in a shift of the platform from horizontal, presenting the risk that an unsecured load may accidentally slide off the cart.

Some related art attempts to address this problem provide a means to secure the load, such as by tie-down strapping as in U.S. Pat. No. 9,834,241 (infra). A limitation of the tie-down approach is, first, the extra time required to tie down the cargo upon loading and to remove the ties when the cargo is unloaded. Second, this approach is error-prone, effective only when the ties adequately retain the load.

Another approach for retaining a load in transport is by providing substantially vertical walls around the platform to retain the load in the nature of a wheelbarrow, as in US20020047251A1. A limitation to this approach is that the cargo must be lifted above the walls for loading and unloading, a considerable burden if the cargo is heavy. It is desirable that a hand cart provide means of retaining cargo that is both easy to use and is well suited for heavy loads.

Another problem in the related art is that the typical prior art hand truck, in encountering a surface barrier such as a doorsill, requires extra force by the driver to pass over the barrier. In some situations with heavy loads, the force required to traverse the barrier is actually more than the driver can provide, thereby frustrating transport of the cargo. While motorization as in U.S. Pat. No. 9, 511, 788 provides a solution to this problem, what is needed is an entirely hand-propelled vehicle adapted to traverse such barriers easily.

### SUMMARY OF THE INVENTION

A hand cart provides a handlebar attached to a wheeled frame upon which is disposed a platform for carrying loads. Embodiments of the present invention incorporate sides around the platform, providing walls to prevent loads from sliding off the platform. In embodiments, at least some of these sides are slidable from a raised position to a lowered position to provide access to the load on the platform as in loading and unloading cargo. Some embodiments of the invention have a means for raising and lowering the platform. Such embodiments facilitate the transport of heavy items, in particular, by affording different heights for the loading and the unloading of cargo.

Embodiments of the invention further provide a suspension system. In an embodiment, the cart has three pairs of wheels, one pair in the rear toward the driver, one pair depending from the center of the frame, and one pair depending from the front of the frame. The suspension system facilitates passage of both front and rear wheels over barriers. In such embodiments, the frame comprises two components: a lower frame and a suspension arm. The rear wheels are attached to the suspension arm. The center wheels and front wheels are directly attached to the lower frame. One end of the suspension arm is connected to the lower frame near the center, preferably in line with the axles of the center wheels, the suspension arm pivoting at that connection. The suspension arm extends backward, and at or near the other end of the suspension arm the rear wheels are attached. The suspension arm is further suspended on the lower frame by one or more compression springs or similar contrivances interposed somewhere along the arm, providing resistance but allowing the arm to pivot and bring the rear wheels closer the lower frame.

In these embodiments, the suspension system facilitates cart transport, keeping the cart generally level on uneven surfaces. If the rear wheels go over a bump, the rear wheels (which are on the suspension arm) move up, leaving the lower frame and the rest of the cart generally as level as the ground under the front and center wheels. If the front wheels go over a bump, the lower frame, (and the rest of the cart except for the suspension arm and rear wheels) tilts backwards. The suspension in the rear allows the tilt as the tilt pushes the rear part of the lower frame closer to the suspension arm. In some embodiments, a foot plate is attached to the rear of the lower frame, enabling a user to tilt the lower frame back by stepping on the foot plate, thereby lifting the front wheels for passage over barriers.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description with reference to the accompanying drawings, all of which form a part of this specification, wherein like reference numerals designate corresponding parts in the various figures, and wherein:

FIG. 1 is an elevational view of an embodiment of the invention having a means for raising and lowering the platform, here shown in the raised position;

FIG. 2a is a partial elevational view of an embodiment as in FIG. 1, in which the platform is shown in the lowered position;

FIG. 2b is a component used to retain a side wall in an embodiment of the invention;

FIG. 2c is a component for releasably retaining a side wall in the raised position in an embodiment of the invention;

FIG. 3 is an elevational view of an embodiment as in FIG. 1, in which three sides of the platform are shown in the lowered position;

FIGS. 4a and 4b illustrate the suspension functionality of an embodiment of the invention;

FIG. 5 is a detail of the rear of an embodiment of the invention, showing a foot plate; and

FIG. 6 is a detail of the suspension system in an embodiment of the invention.

### DETAILED DESCRIPTION OF THE INVENTION

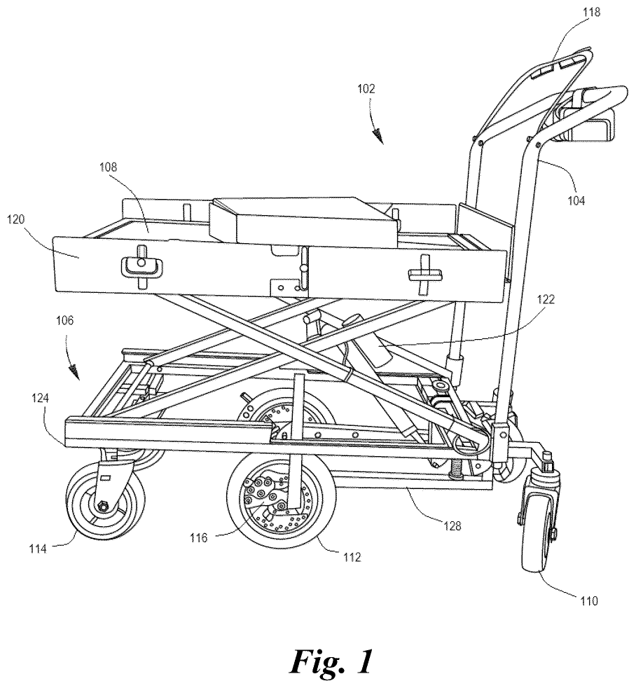

FIG. 1 is an elevational view of an embodiment of the invention as seen from the left hand side. Hand cart 102 comprises a handlebar 104 connected to a wheeled frame 106 upon which is disposed a platform 108 for carrying cargo. Depending from frame 106 are rear caster wheels 110, center wheels 112 and front castor wheels 114. Center wheels 112 are on fixed axles and comprise normally engaged brakes 116, operationally connected to brake lever 118. Cart 102 further comprises one or more raisable side panels 120. This embodiment has a linear actuator 122 providing a means for raising and lowering platform 108, here depicted in the raised position, via a scissoring arrangement familiar to those in the art.

In the depicted embodiment, handlebar 104 is comprised of round tubing. Embodiments may employ 1″OD×0.065″ round steel tubing for such purpose. Components of frame 106 include lower frame 124 and suspension 128. In an embodiment of the invention, suspension 128 is fashioned of 0.75″×0.75″×0.065″ square steel tubing, while lower frame 124 and other components of frame 106 are comprised of square steel tubing of dimensions varying from 1″×1″x 0.065″ to 1″×1″×0.125″.Because it is used only for operating brakes 116, brake lever 118 can be fashioned from a small diameter rod, such as 0.25″ steel.

The floor of platform 108 may be any sheet material with requisite strength and rigidity for supporting cargo. Embodiments employ sheet plastic of appropriate dimensions for this purpose. Similarly, side panels 120 may be fashioned of sheet plastic providing rigidity without adding substantial weight to the cart. Other embodiments may employ other suitable lightweight sheet material for these purposes.

In this embodiment, front castor wheels 114 are attached to lower frame 124 near the front corners of the cart, and rear castor wheels 110 are attached to suspension 128, which extends slightly behind the back of lower frame 124. Embodiments employ SF—SUPER-SOFT WHEELS of 6 inches in diameter and 2 inches in width from Access Casters of Chicago, Illinois, caster wheels 110, 114 attached to threaded stem casters.

In the depicted embodiment, center wheels 112 may comprise 8.5 inch by 2 inch wheels sold on Amazon.com as replacement wheels for the M365 electric Scooter solid tire with hub and brake-disc from Elkatech. Brakes 116 are normally engaged via calipers acting on the brake disc affixed to center wheels 112. The user disengages the calipers by pulling brake lever 118.

While embodiments depicted herein have two front castor wheels and two rear castor wheels, other embodiments may employ only one front castor wheel, or one rear castor wheel, or one castor wheel each at front and rear. Such embodiments are within the scope of the invention.

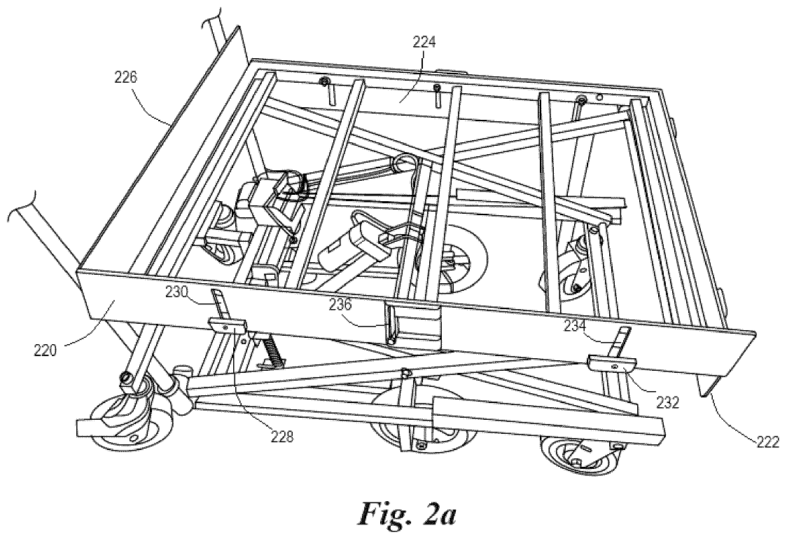

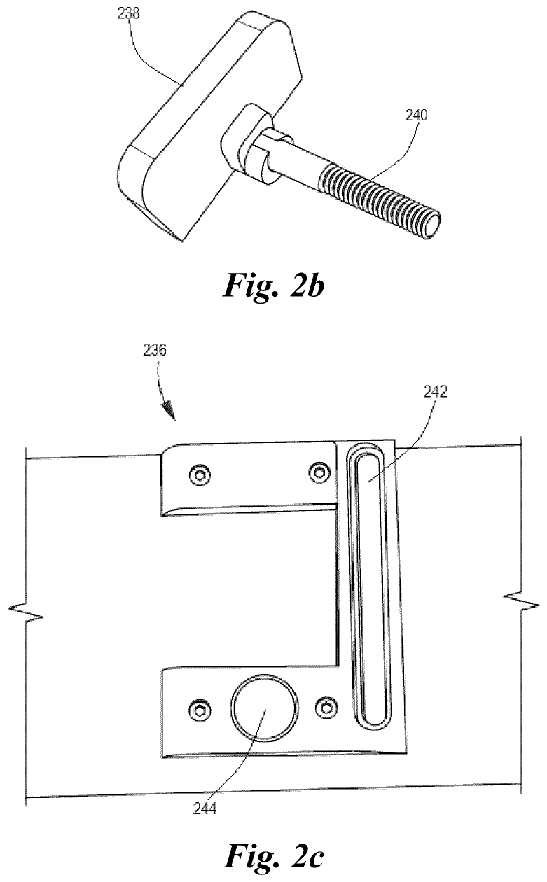

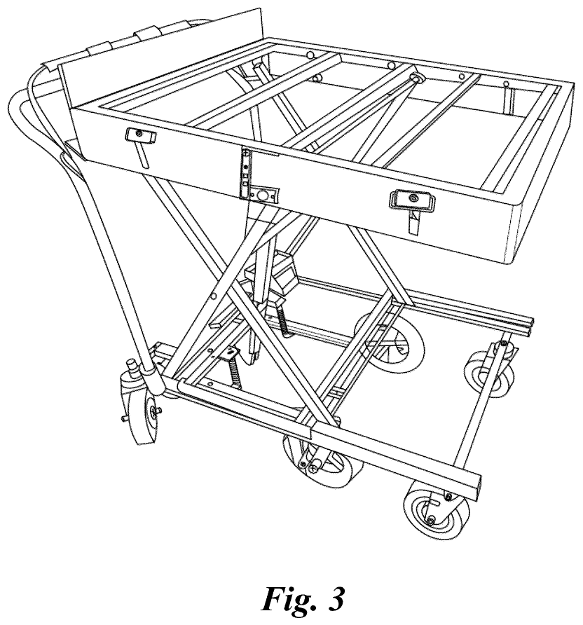

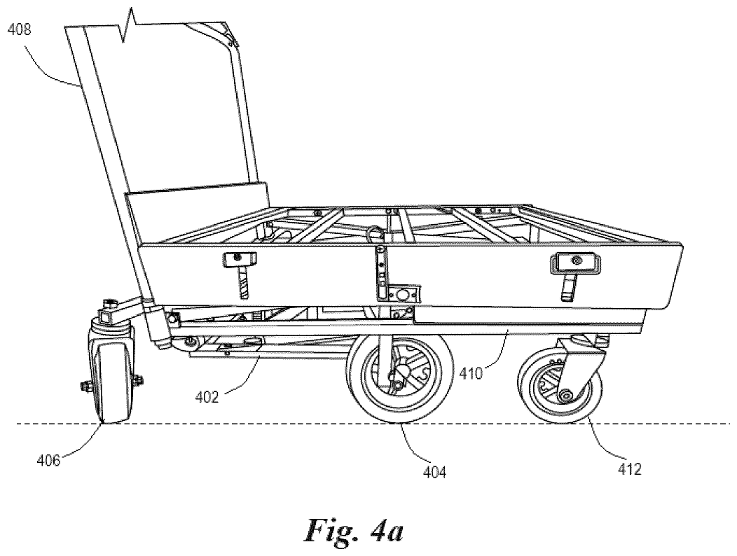

FIG. 2a depicts an embodiment as in FIG. 1 seen from the right hand side, with the platform in the lowered position and the floor of the platform removed in order to reveal construction. Here, the platform is surrounded by panels: right side panel 220, front side panel 222, left side panel 224 and rear panel 226. In this embodiment, side panels 220, 222 and 224 are fashioned so that they may be raised to enclose the platform along with fixed rear panel 226. In raised position, the panels serve to keep cargo from sliding off the platform. A user may lower the side panels to facilitate loading and unloading cargo from the platform, as depicted in FIG. 3. In the depicted embodiments, each side panel may be raised or lowered independently. As depicted in FIG. 2a, right side panel 220 is in the raised position while front panel 222 and left side panel 224 are in the lowered position, while in FIG. 3 all side panels are lowered.

Embodiments may employ various means for raising and lowering such panels. Typically, such means provide a facility for a user to lift and secure a panel in the raised position, further allowing the user to release the panel to drop to the lowered position. Such means typically also provide guidance for panel movement between raised and lowered position.

In the depicted embodiment on right side panel 220, retaining slots 230 and 234 each engage with a wall fastener, 228, 232 respectively, to guide and retain the panel as it is raised and lowered. FIG. 2b shows a wall fastener comprising a plastic head 238 on a threaded bolt 240. In practice, threaded bolt 240 passes through a retaining slot in a side panel into a corresponding hole in the cart frame below the platform, secured therein by a nut, tightened sufficiently to enable head 238 to retain the panel against the cart but loosened sufficiently to allow the panel to slide up and down. Wall fasteners engaging the slots thereby provide guidance for the panel as it is raised and lowered.

In embodiments, a side panel is releasably secured in the raised position operation of a locking mechanism, herein depicted for right side panel 220 as panel lock 236. FIG. 2c shows detail of one side of panel lock 236. Panel lock 236 itself has a slot 242 corresponding to a retaining slot in the side panel to which it is attached. A bolt is passed through slot 242, through the retaining slot in the side panel and then secured to the cart frame below the platform by a nut, tightened as described above for the wall fasteners, thereby providing additional guidance for the panel as it is raised and lowered.

Panel lock 236 further has a release button 244. Attached to the cart frame is a spring loaded detent, so aligned with panel lock 236 that the detent is depressed when the corresponding panel is lowered, allowing up and down movement of the panel. When, however, the panel is lifted to a fully raised position, the spring loaded detent extends through an engagement hole in the panel into a corresponding depression in panel lock 236, thereby securing the panel in the raised position. Panel lock 236 further comprises an arrangement whereby a user's depressing of release button 244 causes depression of the detent, thereby allowing release of the panel for lowering.

Many other means for enabling panels to slide up and down and to be releasably secured in the raised position may be employed in other embodiments. These include but are not limited to simple hand tightening bolts or screws, side-mounted guide rails, cog mechanisms and cabling, as well as other approaches to employing engageable spring-loaded detents. The present invention contemplates all embodiments providing this functionality.

Other embodiments may employ sides that fold out as an alternative to sliding down to afford access to the platform for loading and unloading cargo, the sides folding up to retain the cargo. Such embodiments may be implemented by locking hinge mechanisms allowing sides to be folded down away from the platform.

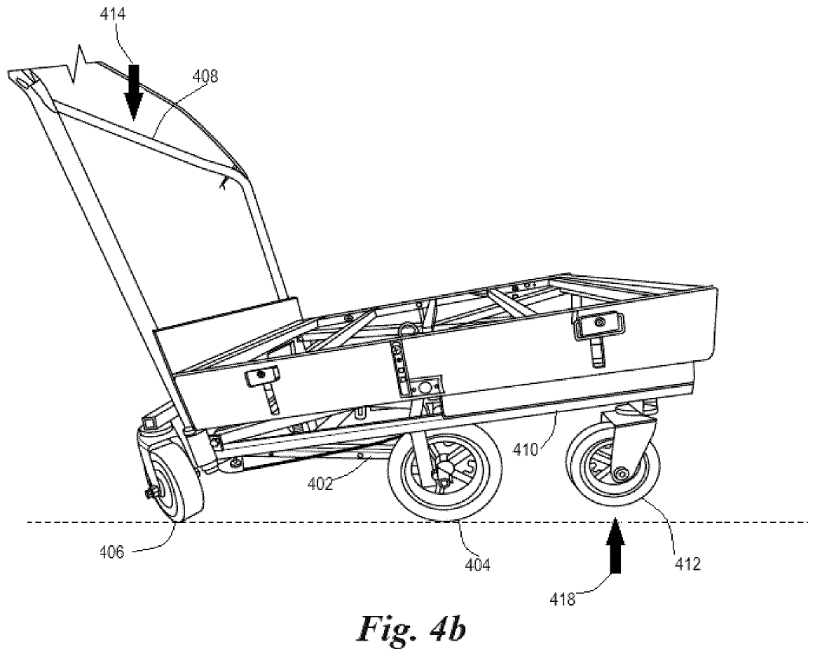

Embodiments of the invention provide a suspension functionality. Turning to FIGS. 4a and 4b, the frame for an embodiment of the hand cart contains a lower frame 410 connected to center wheels 404 and front wheels 412, as well to handlebar 408. The frame further contains a suspension arm 402 from which rear wheels 406 depend. Suspension arm 402 is pivotingly connected to lower frame 410 at or near the axle of center wheels 404.

When a user applies downward pressure on handlebar 408 (shown here as downward arrow 414) or when the front wheel is upwardly displaced by a barrier (shown here as upward arrow 418), lower frame 410 can pivot backward on center wheels 404, lifting front wheels 412, because suspension arm 402 pivots to allow rear wheel 406 to pivot upward relative to lower frame 410. In this manner, load on front wheels 412 can be reduced to facilitate passage over barriers. Similarly, when rear wheels 406 encounter a barrier, upward displacement of the wheels by the barrier results in relative lift of rear wheels 406 by way of the pivoting of suspension arm 402 on lower frame 410.

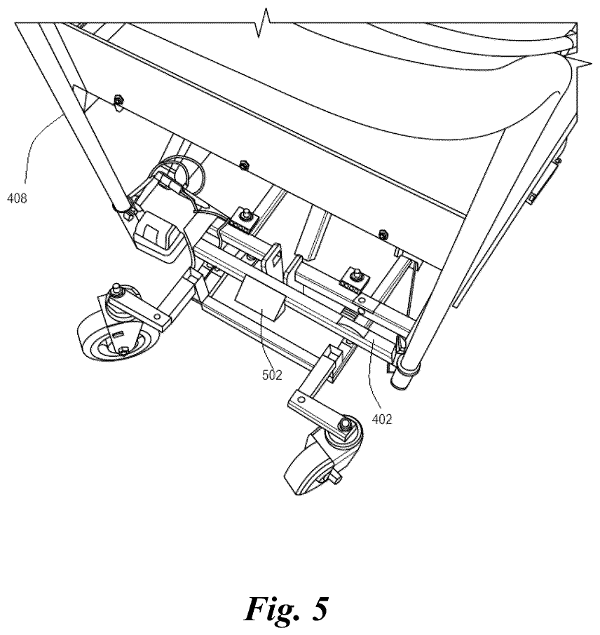

Referring to FIG. 5, some embodiments of the invention further provide a foot plate 502 attached to lower frame 410, enabling the user to step on the plate to provide additional downward pressure (as in 414 in FIG. 4b) on the rear of the lower frame typically for the purpose of lifting the front wheels.

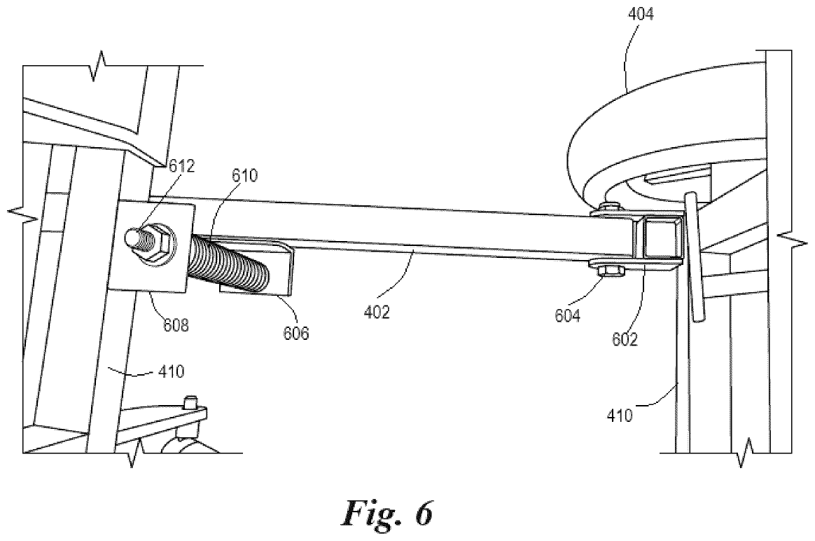

Turn now to FIG. 6 for details of a pivoting connection of the suspension bar to the lower frame in some embodiments of the invention. As depicted for the left side of the cart, welded to the lower frame 410 is a simple u-connector 602 hingedly engaging the suspension bar 402 proximate the axle of center wheel 404 via a bolt 604 passed through u-connector 602 and suspension bar 402, bolt 604 serving as a pivot point to allow pivoting of suspension bar 402 in a vertical plane. The depicted embodiment has two such pivot points, one on the right side and one on the left side of the frame. As will be appreciated by those of skill in the art, the pivot points of the present invention may be implemented in other ways than that described in the foregoing, including but not limited to pivoting by bearings or bushings and other hinge mechanisms, and are contemplated to provide the required pivoting functionality afforded by the invention.

In the depicted embodiment, a helical compression spring is disposed between the lower frame and the suspension bar for each of the two pivot points, the spring providing compressible downward force on the suspension bar. In this depiction for the left side of the cart, spring 610 is disposed between lower L-bracket 606 affixed to suspension bar 402 and upper L-bracket 608 affixed to lower frame 410. Bolt 612 secures spring 610 and passes loosely through a hole in upper L-bracket 608, whereby when downward force on lower frame 410 or upward force on suspension arm 402 causes suspension arm 402 to pivot, bolt 612 emerges from upper L-bracket 608 thereby allowing compression of spring 610, passing downward force to suspension arm 402. A counterpart arrangement is provided on the right side of the cart. Persons of skill in the art will understand that the invention may comprise alternative mechanisms, including but not limited to hydraulic or pneumatic cylinder/piston configurations as well as leaf springs, to provide the requisite compressible downward force instead of the depicted helical springs.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the invention.

What is claimed is:

1. A hand cart, comprising:
a platform disposed upon and connected to a wheeled frame, the wheeled frame comprising:
a handlebar;
a lower frame, comprising
at least one front caster wheel,
two center wheels having a user-operable brake;
a suspension arm comprising at least one rear caster wheel, the suspension arm hingedly connected to the lower frame proximate the two center wheels; and
a source of downward compressible force between the suspension arm and the lower frame.

2. The hand cart according to claim 1, wherein the source of downward compressible force is one of a coiled helical spring, a set of leaf springs, a hydraulic piston and cylinder, and a pneumatic piston and cylinder.

3. The hand cart according to claim 1, wherein the user-operable brake is normally engaged and is releasable only by user operation.

4. The hand cart according to claim 1 having two front caster wheels and two rear caster wheels.

5. The hand cart according to claim 1, wherein the platform further comprises vertical sides surrounding the platform.

6. The hand cart according to claim 5, wherein at least one of the vertical sides is releasably slidable to expose the platform.

7. The hand cart according to claim 5, wherein at least one of the vertical sides is releasably foldable outward to expose the platform.

8. A hand cart, comprising:
a handlebar connected to a wheeled frame; and
a platform disposed upon and connected to the wheeled frame, the platform further comprising vertical sides surrounding the platform, at least one of the vertical sides releasably slidable down to expose the platform.

9. The hand cart according to claim 8, wherein a plurality of the vertical sides are independently releasably slidable down to expose the platform.

10. The hand cart according to claim 8, wherein the wheeled frame comprises:
a lower frame, comprising
two front caster wheels,
two center wheels having a user-operable brake;
a suspension arm comprising two rear caster wheels, the suspension arm hingedly connected to the lower frame proximate the two center wheels, and one or more coiled helical springs providing downward compressible force between the suspension arm and the lower frame.

11. The hand cart according to claim 8, further comprising a user-operated means for raising and lowering the platform on the wheeled frame.

12. A hand cart, comprising:
a platform for transport of cargo;
vertical sides surrounding the platform, at least one of the vertical sides releasably slidable down to expose the platform;
the platform disposed upon and connected to a wheeled frame, the wheeled frame comprising:
a handlebar;
a lower frame, comprising:
two front caster wheels;
two center wheels having a user-operable brake;
a suspension arm comprising two rear caster wheels, the suspension arm hingedly connected to the lower frame proximate the two center wheels; and
two coiled helical springs providing downward compressible force between the suspension arm and the lower frame.
